(19) United States
(12) Patent Application Publication
(10) Pub. No.: US 2012/0141709 A1
(43) Pub. Date: Jun. 7, 2012

(54) PROTECTIVE COVER AND ELECTRONIC DEVICE USING THE SAME

(75) Inventor: MING-CHUN HSIUNG, Shindian (TW)

(73) Assignee: FIH (HONG KONG) LIMITED, Kowloon (HK)

(21) Appl. No.: 13/043,642

(22) Filed: Mar. 9, 2011

(30) Foreign Application Priority Data
Dec. 1, 2010 (CN) 201010568573.6

(51) Int. Cl. B32B 15/08; B32B 1/02

(52) U.S. Cl. 428/35.8; 428/457

(57) ABSTRACT

An electronic device includes a housing and a protective cover assembled to the housing. The protective cover includes a main body and a metal sheet. The main body includes a plastic layer and a rubber layer stacked on the plastic layer. The metal sheet is adhered to the plastic layer. The present invention further discloses a protective cover used for the electronic device.

### BACKGROUND

1. Technical Field

The present disclosure relates to protective covers, and particularly, to an electronic device using a protective cover.

2. Description of Related Art

Electronic devices, such as mobile phones are widely used. Many mobile phones use a chip card for storing information. The chip card may also contain personal information for the subscriber, for example, a listing of frequently used telephone numbers. To receive the chip card, the mobile phones usually define a receiving chamber and an entrance hole communicating with the receiving chamber. To prevent dust or water entering the receiving chamber from the entrance hole, a protective cover is used to cover the entrance hole. The protective cover includes a sheet and a connecting portion positioned on the sheet for connecting to a housing of the mobile phones. The sheet may include a rubber layer and a metal layer formed at a side of the rubber layer. Because a bonding force between the rubber layer and the metal layer is not strong. Thus, the metal layer may be easily detached from the rubber layer.

Therefore, there is room for improvement within the art.

### BRIEF DESCRIPTION OF THE FIGURES

Many aspects of the protective cover and electronic device using the same can be better understood with reference to the following figures. The components in the figures are not necessarily drawn to scale, the emphasis instead being placed upon clearly illustrating the principles of the protective cover and electronic device using the same. Moreover, in the drawings like reference numerals designate corresponding parts throughout the several views.

FIG. 1 is an assembly, isometric view of an exemplary embodiment of an electronic device.

FIG. 2 is an exploded, isometric view of the electronic device shown in FIG. 1.

FIG. 3 is a cross-sectional view of a protective cover shown in FIG. 2, taken along line III-III.

### DETAILED DESCRIPTION

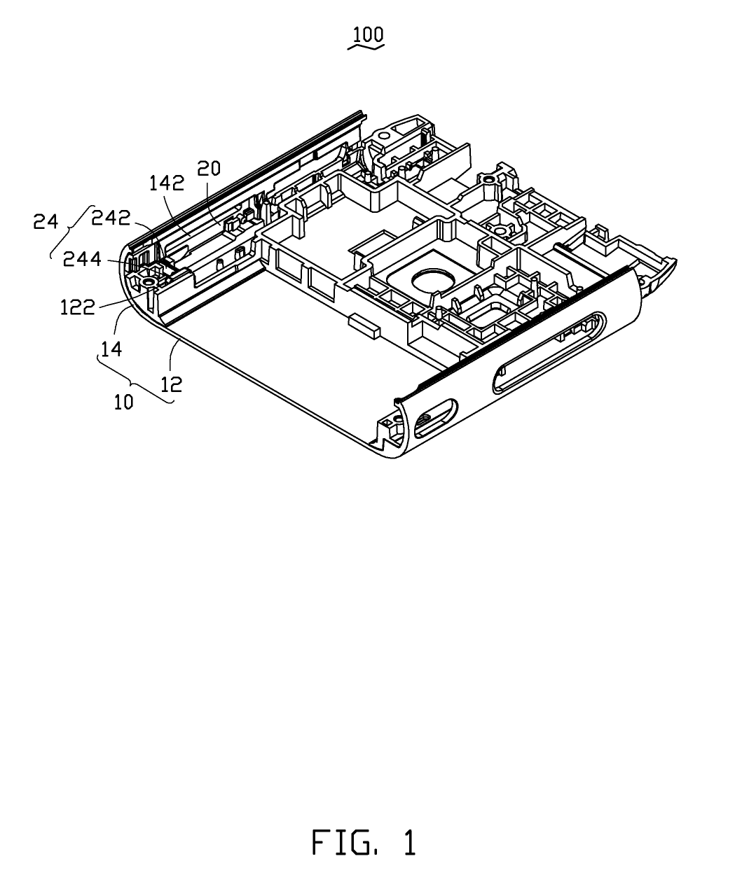

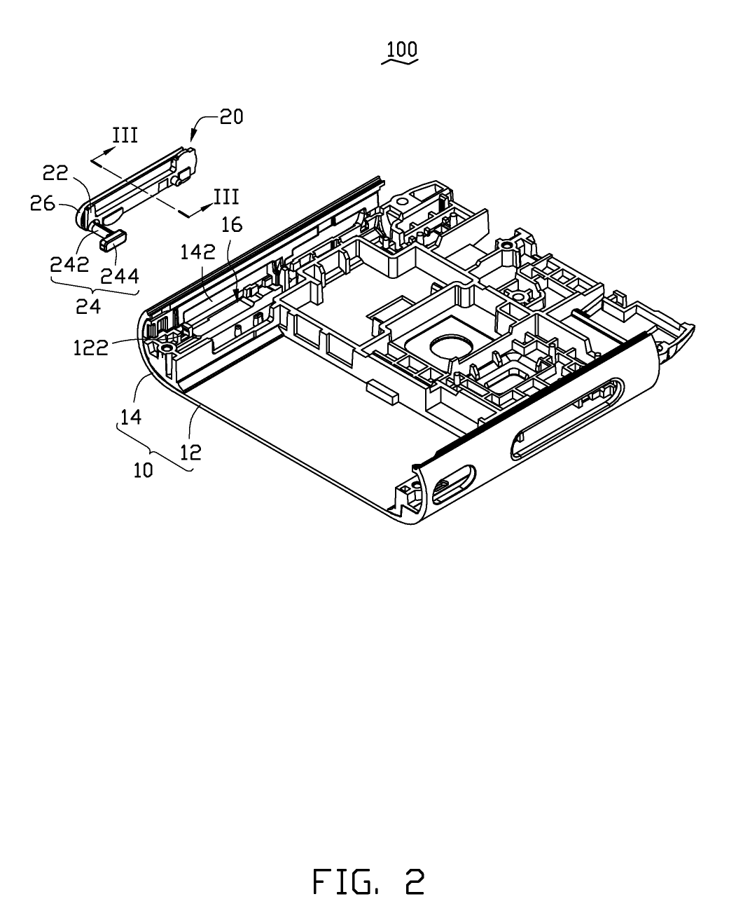

The present invention discloses a protective cover used for electronic devices, such as mobile phones and personal digital assistants (PDAs) to protect a chip card (not shown). FIG. 1 and FIG. 2 show an exemplary electronic device 100 including a housing 10 and a protective cover 20 assembled to the housing 10. The housing 10 includes a bottom wall 12 and two opposite sidewalls 14 cooperatively defining a receiving chamber 16 for receiving the chip card. A connecting portion 122 is mounted on the bottom wall 12 adjacent to one of the sidewalls 14. The connecting portion 122 is configured for fixing the protective cover 20 to the housing 10. A through hole 142 is defined in the sidewall 14 which adjacent to the connecting portion 122. The through hole 142 communicates with the receiving chamber 16. Therefore, the through hole 142 can be used as an entrance hole and the chip card can be inserted or removed from the receiving chamber 16 through the hole 142.

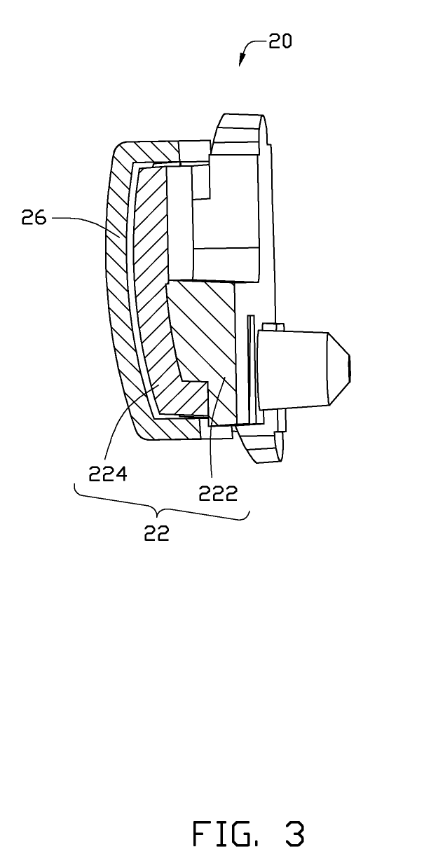

Referring to FIG. 3, the protective cover 20 includes a main body 22, an assembly portion 24 extending from one side of the main body 22, and a sheet 26 covering the other side of the main body 22. The main body 22 includes a rubber layer 222 and a plastic layer 224 stacked on the rubber layer 222. The plastic layer 224 is positioned between the rubber layer 222 and the sheet 26. The rubber layer 222 may be integrally formed with the plastic layer 224 by double shot molding. The rubber layer 222 also may be adhered to the plastic layer 224 by glue. Furthermore, the rubber layer 222 can be formed by injection molding, then the plastic layer 224 is formed with the rubber layer 222 by insert molding. The assembly portion 24 may be T-shaped and integrally formed with the rubber layer 222. The assembly portion 24 includes a connecting post 242 and a latching portion 244 positioned at one end of the connecting post 242. The other end of the connecting post 242 connects to the rubber layer 222. The latching portion 244 can be latched to the connecting portion 122. Thus, the protective cover 20 can be fixed to the housing 10. The sheet 26 is adhered to the plastic layer 224 by glue. The sheet 26 may be made of metal, such as aluminum or aluminum alloy.

In assembly, the assembly portion 24 passes through the through hole 142 and is received in the receiving chamber 16. The latching portion 244 is latched to the connecting portion 122. Therefore, the protective cover 20 is assembled to the housing 10.

A bonding force between the metal sheet 26 and the plastic layer 224 is stronger than the bonding force between the metal sheet 26 and the rubber layer 222. Therefore, the sheet 26 can be firmly adhered to the plastic layer 224.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A protective cover, comprising:
a main body comprising a plastic layer and a rubber layer stacked on the plastic layer; and
a metal sheet adhered to the plastic layer.

2. The protective cover as claimed in claim 1, further comprising an assembly portion connecting to the rubber layer.

3. The protective cover as claimed in claim 2, wherein the assembly portion is integrally formed with the plastic layer.

4. The protective cover as claimed in claim 1, wherein the plastic layer is integrally formed with the rubber layer by double shot molding.

5. The protective cover as claimed in claim 1, wherein the sheet is made of aluminum or aluminum alloy.

6. An electronic device, comprising:
a housing; and
a protective cover assembled to the housing, the protective cover comprising:
a main body comprising a plastic layer and a rubber layer stacked on the plastic layer; and
a metal sheet adhered to the plastic layer.

7. The electronic device as claimed in claim 6, wherein the protective cover comprises an assembly portion connecting to the rubber layer; the housing comprises a connecting portion, the assembly portion is latched to the connecting portion.

8. The electronic device as claimed in claim 7, wherein the assembly portion is integrally formed with the plastic layer.

9. The electronic device as claimed in claim 6, wherein the plastic layer is integrally formed with the rubber layer by double shot molding.

10. The electronic device as claimed in claim 6, wherein the sheet is made of aluminum or aluminum alloy.
